(19) United States
(12) Patent Application Publication
(10) Pub. No.: US 2009/0134279 A1
(43) Pub. Date: May 28, 2009

(54) Tombola kite flyer

(76) Inventor: Maximino Villalta-Gomez, Arlington, VA (US)

Correspondence Address: VENABLE LLP, P.O. BOX 34385, WASHINGTON, DC, 20043-9998, US

(21) Appl. No.: 11/984,940

(22) Filed: Nov. 26, 2007

(51) Int. Cl. B64C 31/06

(52) U.S. Cl. 244/155 A

(57) ABSTRACT

A kite reel for controlling the movement of a kite at high elevations and for winding the kite at a fast pace includes a three-dimensional frame and a rod inserted through the three-dimensional frame. The frame has a weight, two sides, a central axis through the two sides, and an edge between the two sides that is adapted for reception of a length of kite string or line about the frame as it rotates. The rod is inserted through the two sides of the frame at a distance from the central axis. A user holds the rod extending on both sides of the frame and moves the frame up and down so that the off-centered rod together with the weight of the frame and the motion of the user controls the movement of a kite a high elevations and controls the winding and unwinding of the line.

### FIELD OF THE INVENTION

The present invention is directed to a kite reel which allows the user to elevate and direct a kite with ease and speed.

### BACKGROUND OF THE INVENTION

Kite flying has been around for centuries. From the kite that Ben Franklin flew to learn about electricity to the decorative kites that are flown on beaches, fields, and parks of present day, kites require a frame, string or wire of indeterminate length to let the kite out into the wind and a reel to hold string. Most kites have a tail to keep the kite balanced in the wind. These conventional kites may use a kite reel, such as disclosed in U.S. Pat. Nos. 4,014,477 to Hyun and 4,153,222 to Than.

Both Hyun and Than disclose a reel have a central shaft with central handles. While Than addresses the drag force of the reel, it is only concerned with letting string or wire out from the reel and does not address controlling the flying of the kite or reeling in the string or wire. Similarly, Hyun discloses that the central shaft and handle are used to hold the reel for pay-out. Hyun also discloses that handle 14 can be rotated by a user, or the user can grasp the handle with one hand and grasp a crank handle sleeve to rotate the reel and wind in the string or wire. However, cranking motion effects the control one has of the flying kite. Conventional reels do not enable one to fly the kite higher by quickly paying-out the kite string, provide better control of the flying kite and enable one to bring the kite in faster.

Therefore, there exists a continuing need for a new and improved kite reel that is simple to use, gives the kite flyer a high degree of control at higher elevations, allowing the kite flyer to easily manipulate the kite to do acrobatics, and very quickly pay-out and reel in string or wire attached to the kite.

### BRIEF SUMMARY OF THE INVENTION

In summary, a kite reel for controlling the movement of a kite at high elevations and for winding or unwinding the kite at a fast pace, includes a frame having a weight, two sides, a central axis through the two sides, and an edge between the two sides adapted for reception of a length of line about the frame as it rotates; and a rod inserted through the two sides at a distance from the central axis where a user holds the rod extending on both sides of the frame and moves the frame up and down so that the off-centered rod together with the weight of the frame and the motion of the user controls the movement of a kite a high elevations and controls the winding and unwinding of the line.

In addition, a kite system for doing acrobatic tricks and battling other kites in the air including the kite reel above and a kite for acrobatic tricks and a method of flying a kite using the kite reel are disclosed.

Further objectives and advantages, as well as the structure and function of preferred embodiments, will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 illustrates a person using the tombola reel to fly a kite;

FIG. 2 is a side view of an embodiment of the tombola reel according to the present invention;

FIG. 3 is a partial perspective view of the tombola reel shown in FIG. 2 with string or wire wrapped around the frame; and

FIG. 4 depicts an exemplary embodiment of a kite used with the tombola reel according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

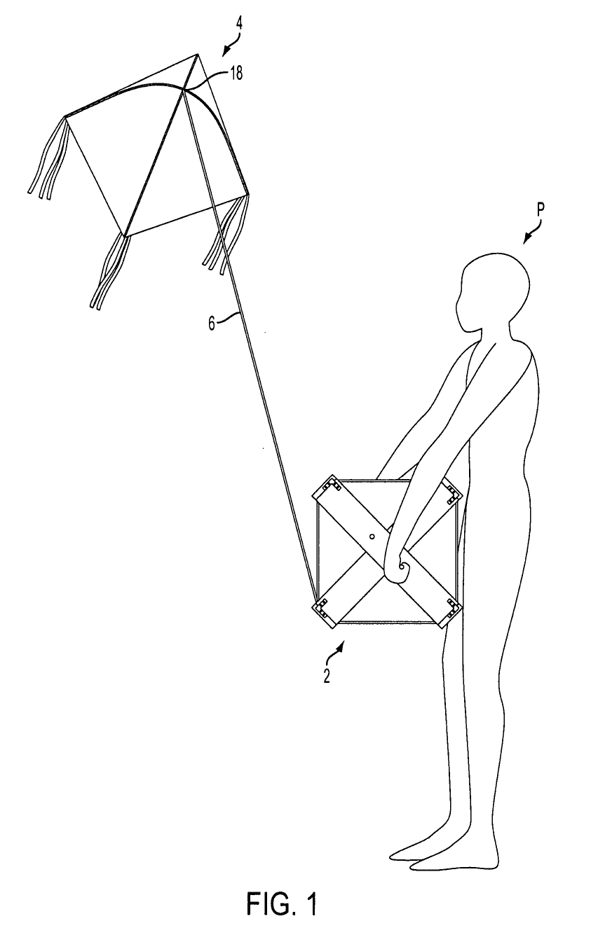

As shown in FIG. 1, the tombola reel 2 is attached to a kite 4 via string or wire 6. The string 6 may be made out of nylon. A person P or user holds the tombola reel 2 with their two hands, arms extended so that the tombola reel 2 is held between the person's arms away from their body. The tombola reel 2 can be made to different sizes (e.g., smaller for children) and can be made of differing materials depending upon the weight of the frame desired. The tombola reel 2 is user friendly and can be a fun diversion for all ages.

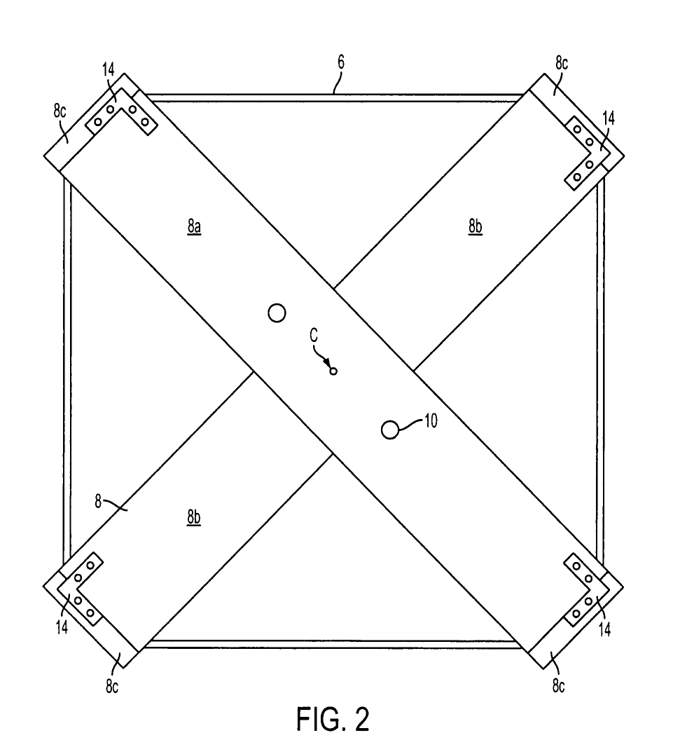

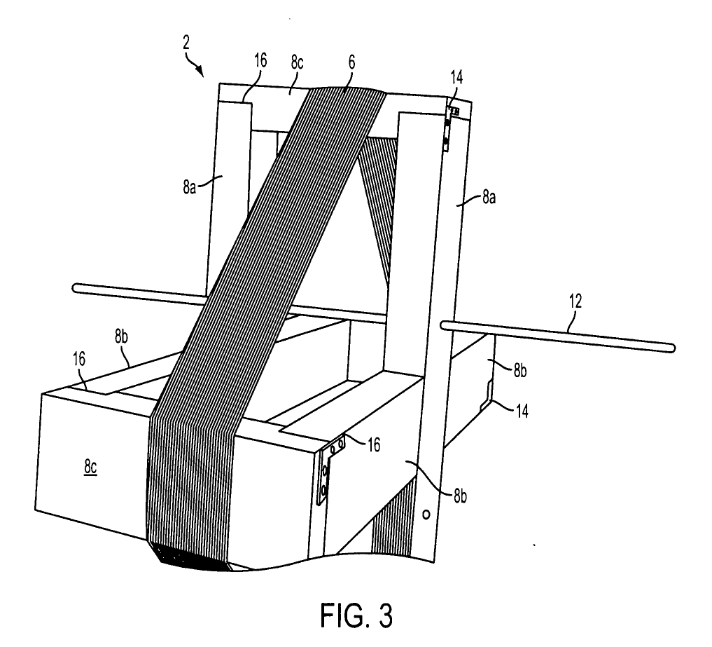

In operation, the tombola reel is held so that it is away from the body of the person P. Looking at FIGS. 2 and 3, the tombola reel 2 has a three-dimensional frame 8 having a generally square form and may be constructed of solid wood in a rectangular criss-cross pattern. The three-dimensional frame 8 has two sides, each may be formed in the shape of the letter “X” as shown in FIG. 2 with cross braces 8a, 8b. Cross brace 8a may be a 2×4 piece of wood that is all one length. A smaller cross brace 8b is attached to both of the 2″ sides of cross brace 8a to from the shape of the letter “X”. With the “X”-shaped cross braces, cross brace 8a and cross braces 8b together with the width of cross brace 8a would be about the same length to form a generally square shaped tombola reel 2.

On either side of the center point C of cross brace 8a, a through bore 10 is drilled through the three-dimensional frame 8. The through bore 10 may be about half an inch in diameter and receives a rod 12 that is smaller in diameter and extends through the bores 10 on either side of the frame 8 in a plane off-center and parallel to the center C of the tombola reel 2. The rod 12 should extend a sufficient distance on either side of three-dimensional frame 8 so that a user can comfortably hold his/her arms out in front of his/her body. Rod 12 can be made of metal, wood or hard plastic.

The three-dimensional frame 8 has an edge 8c around which the kite string or wire 6 is wound. That is, each cross brace has two sides and a edge between each side. For example, if the three-dimensional frame 8 is formed in the shape of the letter “X”, each side of a cross brace is connected with an edge 8c. Edge 8c may be a 2×4 wood board with cut-outs or grooves forming a “T”-shaped edge. For example, each end of the board of edge 8c may have an “L” shaped groove 16 for receiving a cross brace so that the created three-dimensional frame 8 is sturdy as the “L” shaped groove 16 provides support for a respective side of the frame 8. If the tombola reel 2 is made out of wood, L-shaped brackets 14 can be used to attach cross braces 8a to edge 8c and/or cross braces 8b to edge 8c. The width of the three-dimensional frame or the length of the edge 8c determines the length of or the amount of wire or string that can be handled by the tombola reel 2.

FIG. 1 shows a person P holding the tombola reel 2 in the stopped position. The position of the person P's hands on either side of frame 8 depends upon whether the kite is being released to higher elevations, or whether the kite is being reeled in. The left hand grasps rod 12 in the pocket formed by its thumb and its forefinger and the right hand grasps rod 12 in the pocket formed by its thumb and its forefinger. The initial left hand position for letting string or wire out so that the kite can reach higher elevations has the four fingers wrapped against an edge if cross brace 8a with the rod 12 in the pocket of the thumb and forefinger.

The kite 4 is placed about 10 feet away from the tombola reel 2 with the top of the kite pointing toward the tombola reel. Then, the user waits for a mild breeze and lifts the tombola reel 2 using the rod 12 over or above his/her head while bending at the elbows. As the kite 4 lifts off the ground, the four fingers of the user push against edge 8a causing the tombola reel 2 to move in a counterclockwise rotation thereby releasing string or wire so that kite 4 can move to higher elevations. As the kite steadies in the air or sky, the user can control the kite by hand movements described below.

During the counterclockwise rotation, the four fingers of each hand are straight while the thumb and forefinger of each hand hold rod 12 of the tombola reel 2. The person P's arms are held relatively straight as the arm muscles cause the tombola reel 2 to rotate by pushing the same away from the person's body so that it rotates due to the motion (impulsion). That is, the force generated by the slight movement of the arm causes the three-dimensional frame 8 to move up and down so that the tombola reel 2 rotates allowing string or wire to be released and the kite 4 to climb in altitude.

A person using the tombola reel 2 does not have to use exaggerated arm motions to cause the tombola reel 2 to rotate. Slight up and down movement of the arms with the arm muscles tightened together with a slight rotating action is sufficient. It is the up and down movement of the frame 8 together with the position of the off-centered rod 12 and the weight of the frame that controls the movement of the kite to higher elevations and controls the winding and unwinding of the kite string or wire. Kites can be flown to higher elevations and longer distances with the tombola reel 2. Kites can be flown to distances or heights beyond the user's eyesight. If the wind is strong enough, the user can simply release his/her fingers from the frame of the tombola reel 2 and allow the wind to propel the tombola reel forward unwinding the kite string 6.

When a user of the tombola reel 2 is ready to bring in the kite 4, a hand position is used that is similar to releasing the string. Although this time, the four fingers are positioned to push the tombola reel 2 in the clockwise direction. The user should apply pressure with his/her thumbs to move the tombola reel toward his/her body in a clockwise direction. This allows the kite 4 to be reeled in quickly with minimal energy expenditure. It is easy to pull the kite and string in using one's arm muscles to provide rotary motion of the tombola reel 2.

With this invention, the user can stand in the same place and simply move his/her arms with the slight up and down movement and clockwise rotation. The user of the tombola reel 2 can very quickly bring kite 4 in with the arm movements described above that cause the tombola reel 2 to rotate quickly. The weight of the tombola reel 2 determines the ease of pulling the kite in. The heavier the weight of tombola reel 2, the easier it is to bring the kite 4 in. The momentum of the rotating tombola reel provides the action to continue reeling in the kite against the wind-related friction of the kite. That is, either a large kite with a larger amount of friction or a smaller kite in heavy winds can be easily reeled in with the tombola reel 2.

Even in light wind conditions, a user can fly a kite with the tombola reel 2 because the tombola reel 2 and the motion of the user assists the kite in moving to higher elevations. In light wind conditions, kite 4 should be elevated in an large open area about 50 feet away from the tombola reel 2. The user then reels the kite and once the kite has elevated a small distance, the string should be released and manipulated using the tombola reel 2 so that the kite continues to climb in altitude. For example, a user may rotate one turn back (clockwise) and two turns of the tombola reel 2 forward (counterclockwise). It is the momentum of the rotating tombola reel 2 together with the back and forth rotation that assists the kite to higher elevations, even in light wind conditions. When the tombola begins to slowdown, a user of the tombola reel 2 simply places their thumbs against one of the cross braces to stop the rotation of the tombola reel 2. Thus, the tombola reel 2 satisfies a need among kite flyers as it succeeds in elevating kites even on a light wind day. On a mild to windy day, a user can fly his/her kite so that it reaches very long distances.

As shown in the Figures, two sets of through bores 10 can be drilled on either side of the center point of the frame 8 to receive the rod 12. However, it is not necessary to drill two sets of through bores 10, as only one set of through bores 10 should be sufficient. The cross brace that is formed by wood pieces 8a, 8b, 8c may be hollow as shown in the Figures. Although, if a heavier weighted frame is desired, the frame may be made of solid material such as plastic or other appropriate weighted material.

The length of each cross brace may be determined by the user. Basically, the tombola reel 2 should be of a size so that the user can comfortably hold his/her arms out at about a 45° angle and rotate the tombola reel 2 without hitting his/her body. The cross brace or the frame may have a length of about 10 inches to 22 inches. The edge of the frame should be wide enough to allow a large amount of kite string wound around it. For example, the width of the frame or length of the edge may be around 7 inches to 12 inches. With the “X”-shaped cross braces, all four braces would be about the same length to form a generally square shaped tombola reel 2. The through bores 10 are drilled about 19% off the center of a cross brace of the three dimensional frame 8.

The tombola reel 2 provides excellent control of a kite and consequently is the perfect kite reel when battling other kites and/or doing acrobatic tricks in the sky. Kite battles are very popular festivals or form of entertainment throughout the world. Kite battles or kite fighting is a sport where kite flyers try to snag each other's kites or cut the strings of other kites from their reels. This sport is very popular in Asian countries, South America, India and Middle Eastern countries. It is important in this sport to have highly maneuverable kites and a reel that can control the movement of the kite in order to avoid a competitor's kite or to “attack” another competitor's kite by rubbing your kite string against an opponent's so that line friction can work to cut the opponent's kite string.

The user of a tombola reel 2 can control the movement of a kite at high elevations and allows faster reeling in or out of the kite than conventional kite reels. The tombola reel 2 has a frame 8 having a weight, two sides, a central axis through center point C on either side of the frame 8 and an edge 8c positioned between the two sides and adapted for the reception of a length of line or kite string about the frame as it rotates in one direction. When the frame is rotated in the other direction, the length of line or kite string is released allowing the kite to reach higher elevations. A rod 12 is inserted through the two sides of the frame 8 at a distance from the central axis (located at center point C) and is of a length so that the user holds the rod 12 extending on both sides of frame 8 and moves the frame up and down with a slight rotational movement so that the off-centered rod 12 together with the weight of the frame and motion of the user controls the winding and unwinding of the line.

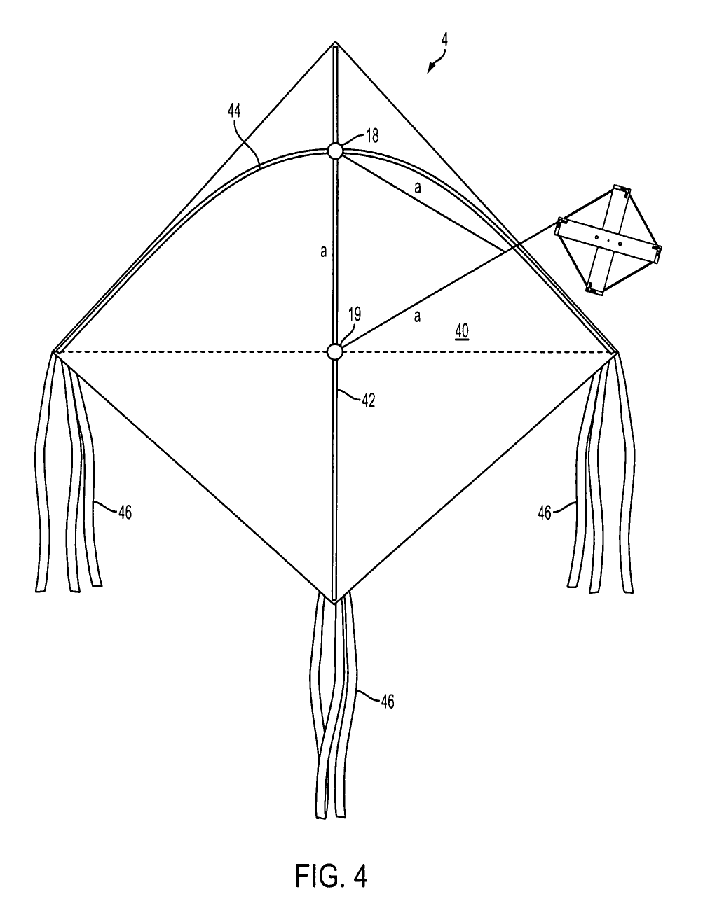

As shown in FIG. 4, a kite 4 that is made for doing acrobatic tricks and for kite battling or fighting is illustrated. A lightweight, elastic plastic sheet 40 that is in the shape of a square forms the body of the kite 4. The Applicant has discovered that square kites fly better than diamond-shaped kites and they are easier to control. Sheet 40 is resilient as opposed to a material that rips easily when in flight. A relatively straight brace 42 extends from one corner of the square sheet to the diagonal corner of kite 4 and is secured to the corners of the square sheet. The other brace for the kite 4 is a curved cross bow 44 that extends across the relatively straight brace between the two remaining corners of the lightweight plastic sheet 40. The ends of the curved cross bow 44 are secured to the two remaining corners. The brace 42 and curved cross bow 44 are made from a flexible wood that is lightweight and bends easily without breaking. The kite 4 is attached to the tombola reel 2 with a string that secures the line or string to the intersection of the brace and the cross bow at point 18 and a point 19 secured to the middle of the kite (dashed line) as shown in FIG. 4 of the drawings. As shown in FIG. 4, one piece of string a is attached to string 6. String a forms a triangle with kite 4 and should be attached to string 6 so that it creates an equilateral triangle, which is attached at points 18 and 19. The string forming the triangle is attached to string 6, which is wound around the tombala.

Kite 4 may have tails 46 that dangle from three to four corners of the kite. A group of tails may be at each of the corners beneath the curved cross bow 44 as shown in FIG. 4. Tails 46 can be made from a curly plastic material and may be the colors of the kite flyer's country. The tails 46 could be made from a nylon fabric. The movement of the tombola reel 2 causes the kite 4 to vibrate as the string is wound or unwound. The vibration of the tails 46 adds interest to the kite 4 and as a result, is pleasant to watch.

A user or person P of the tombola reel 2 grasps the rod extending from either side of the frame 8 with a respective hand; initially the tombola reel 2 is lifted over the person P's head to launch the kite 4 into the air. Then, the user simply has to lift the rod and frame only slightly while apply a force in the counterclockwise or clockwise direction in order to unwind the string or line or reel the line in, respectively. The user then can move the frame up and down and/or to the left or right in order to control the movements of the kite attached to the tombola reel via string 6.

Although the present invention has been described with reference to preferred embodiments, workers skilled in the art will recognize that changes may be made in form and detail without departing from the spirit and scope of the invention.

What is claimed is:

1. A kite reel for controlling the movement of a kite at high elevations and for winding the kite at a fast pace, said kite reel comprising:
a frame having a weight, two sides, a central axis through the two sides, and an edge between the two sides adapted for reception of a length of line about the frame as it rotates; and
a rod inserted through the two sides at a distance from the central axis where a user holds the rod extending on both sides of the frame and moves the frame up and down so that the off-centered rod together with the weight of the frame and the motion of the user controls the movement of a kite a high elevations and controls the winding and unwinding of the line.

2. The kite reel according to claim 1, wherein the frame has a generally square form and the two sides are each formed of cross braces forming the letter “X”.

3. The kite reel according to claim 2, wherein each cross brace has two sides and a edge between each side.

4. The kite reel according to claim 3, wherein holes are drilled spaced a distance from the central axis of the frame on one of the cross braces forming the letter “X” and the holes receive the rod.

5. The kite reel according to claim 4, wherein two sets of holes are drilled on either side of the central axis of the frame for receiving the rod.

6. The kite reel according to claim 3, wherein each cross brace is hollow.

7. The kite reel according to claim 4, wherein the holes are drilled about 19% off the center of the central axis.

8. The kite reel according to claim 3, where the length of each cross brace is about 10 inches to 22 inches and the length of the edge is about 7 inches to 12 inches.

9. The kite reel according to claim 1, wherein the frame is one of wood or plastic.

10. The kite reel according to claim 1, wherein the rod is made from one of, metal or hard plastic.

11. A kite system for doing acrobatic tricks in the air and battling other kites, comprising:
a kite reel for controlling the movement of a kite at high elevations and for winding the kite at a fast pace, said kite reel including:
a frame having a weight, two sides, a central axis through the two sides, and an edge between the two sides adapted for reception of a length of line about the frame as it rotates; and
a rod inserted through the two sides at a distance from the central axis where a user holds the rod extending on both sides of the frame and moves the frame up and down so that the off-centered rod together with the weight of the frame and the motion of the user controls the movement of a kite a high elevations and controls the winding and unwinding of the line; and
a kite made of lightweight, elastic plastic and being made in the shape of a square, the kite including:
a brace from one corner to a diagonal corner of the kite that is relatively straight;
a curved cross bow from another corner to the other diagonal corner; and
a securing device to attach line to the intersection of the brace and the curve cross bow.

12. The kite system according to claim 11, wherein the kite further comprises tails that dangle from the three corners of the kite underneath the curved cross bow.

13. The kite system according to claim 11, wherein the brace and curved cross bow of the kite are made from a flexible wood that bends easily without breaking.

14. A method of flying a kite reel according to claim 1, comprising:
grasping the rod extending from either side of the frame with a respective hand of a user;
lifting the rod and the frame up and down to rotate the frame in order to unwind or reel-in line; and
moving the frame up and down and left to right in order to control the kite flying at high altitudes.

15. The method of flying a kite according to claim 14, wherein the user stands in the same place and rotates the kite reel with arm movements.

16. The method of flying a kite according to claim 14, where the lifting of the rod and frame up and down employs a user's arm muscles to pull the kite line back quickly and causes the kite reel frame to rotate and further comprises using a hand of the user to stop the rotation of the kite reel frame.

17. The method of flying a kite according to claim 14, wherein the weight of the frame assists in the ability to pull the kite in.

18. The method of flying a kite according to claim 14, wherein the momentum of the arm movements can cause the frame to rotate to unwind the line or to wind the line about the frame.

19. The method of flying a kite according to claim 14, wherein the user reels the kite in to elevate the kite a small distance and then releases the string by manipulating the kite reel so that the kite continues to climb in altitude even in light wind conditions.

20. The method of flying a kite according to claim 14, wherein the user stands in the same place rotating the kite reel and using his arm muscles can quickly reel-in in the kite.
